(19) United States
(12) Patent Application Publication
(10) Pub. No.: US 2025/0094604 A1
(43) Pub. Date: Mar. 20, 2025

(54) IMAGE ENCRYPTION USING COLLATZ CONJECTURE

(71) Applicant: Qatar Foundation for Education, Science and Community Development, Doha (QA)

(72) Inventors: Masrat Rasool, Doha (QA); Samir Brahim Belhaouari, Doha (QA)

(21) Appl. No.: 18/826,778

(22) Filed: Sep. 6, 2024

Related U.S. Application Data
(60) Provisional application No. 63/538,136, filed on Sep. 13, 2023.

(51) Int. Cl. G06F 21/60

(52) U.S. Cl. CPC G06F 21/602

(57) ABSTRACT

Example systems, methods, and apparatus are disclosed herein for image encryption using Collatz Conjecture. The proposed technology combines Chaos theory and modified Collatz Conjecture to develop a hashing function that is used to encrypt digital images. The Collatz Conjecture, when combined with chaos theory, has the potential to produce high-quality encryption. The Collatz Conjecture is a tremendously complex mathematical problem, and its application in image encryption enhances the unpredictability and complexity of the process. The proposed technology is compared with various previously documented encryption techniques. The evaluation is conducted using a range of metrics, including histogram analysis, correlation coefficient, mean square error (MSE), number of pixels changes rate (NPCR), unified average change intensity (UACI), entropy, and time complexity.

### PRIORITY CLAIM AND CROSS-REFERENCE TO RELATED APPLICATIONS

The present application claims the benefit of U.S. Provisional Application No. 63/538,136 filed Sep. 13, 2023, which is incorporated herein by reference in its entirety.

### BACKGROUND

The proliferation of smart devices has caused a remarkable increase in digital photos being transmitted over the internet. It is a matter of concern that the privacy of the significant information embedded in these images is gradually becoming vulnerable to being compromised. Thus, safeguarding the privacy and integrity of this data has become vital, necessitating the implementation of robust security measures. Although it is imperative to protect all digital images, it is especially crucial to exercise heightened security protocols in specific domains such as military, medical, political, and business sectors that handle such images. Information hiding and encryption are two primary approaches to safeguarding digital images. Information hiding involves concealing data within the image, and it encompasses techniques such as steganography and watermarking, which have been studied extensively. On the other hand, encryption modifies the image to prevent unauthorized access to the data, making it a crucial security measure that ensures the image's contents are secure. In addition, the image can also be altered to prevent identification, leading to visual and statistical modifications.

To generate encrypted images and minimize the association between neighboring pixels, image encryption employs two main techniques: confusion and diffusion. Substitution is a commonly employed technique to induce confusion in picture encryption, where a substitution map is utilized to replace each pixel value in a digital image. The confusion process is governed by a key responsible for concealing the plaintext image's values. On the other hand, diffusion aims to guarantee that modifying a single pixel in the plaintext image leads to a change in approximately 50% of the cipher image pixels. Similarly, altering a single pixel in the cipher image should impact about half of the pixels in the plaintext image. By employing permutation in image encryption algorithms, diffusion effectively diminishes the correlation among neighboring pixels in an original image.

Digital images are characterized by a high level of inter-pixel correlation, meaning that the values of adjacent pixels in the image are closely related. This property makes digital images more resilient to noise and small changes in pixel values. A slight perturbation in one pixel is unlikely to significantly affect the overall quality of the image, unlike in textual data, where a small modification can drastically alter its meaning. Hence, it can be inferred that conventional encryption methods, such as the Advanced Encryption Standard (AES) and the Data Encryption Standard (DES), are unsuitable for image encryption, primarily due to their high computational complexity and time-intensive nature. In response to the aforementioned challenge, several image encryption algorithms have been developed in recent years. Currently, chaos-based encryption algorithms have been deemed the most realistic since they provide rapid encryption, minimal complexity, and good security while requiring only a moderate computational resources.

A need accordingly exists for addressing the increasing demand for secure information and data access.

### SUMMARY

Example systems, methods, and apparatus are disclosed herein for image encryption using Collatz Conjecture.

In light of the disclosure herein, and without limiting the scope of the invention in any way, in a first aspect of the present disclosure, which may be combined with any other aspect listed herein unless specified otherwise, a system for image encryption based on the Collatz Conjecture including a server, a processor, and a memory storing instructions, which when executed by the processor, cause the processor to apply a cryptographic algorithm based on the Collatz Conjecture.

In a second aspect of the present disclosure, which may be combined with any other aspect listed herein unless specified otherwise, the cryptographic algorithm includes a pixel-to-pixel encryption and a pixel-to-pixel decryption phase.

In a third aspect of the present disclosure, which may be combined with any other aspect listed herein unless specified otherwise, the pixel-to-pixel encryption phase uses a first hash function.

In a fourth aspect of the present disclosure, which may be combined with any other aspect listed herein unless specified otherwise, the pixel-to-pixel decryption phase uses a second hash function.

In a fifth aspect of the present disclosure, which may be combined with any other aspect listed herein unless specified otherwise, a method for image encryption based on the Collatz Conjecture comprising receiving an image, applying a pixel-to-pixel encryption hash function, applying a pixel-to-pixel decryption hash function, and reconstructing the image.

In a sixth aspect of the present disclosure, any of the structure, functionality, and alternatives disclosed in connection with any one or more of FIGS. 1 to 8 may be combined with any other structure, functionality, and alternatives disclosed in connection with any other one or more of FIGS. 1 to 8.

In light of the present disclosure and the above aspects, it is therefore an advantage of the present disclosure to provide users with image encryption using Collatz Conjecture.

It is another advantage of the present disclosure to yield high unpredictability which makes it more difficult for attackers to estimate or reverse-engineer the hash values, improving the hash function's security.

It is yet another advantage of the present disclosure to provide a potential for improved resistance to collision attacks. Collision attacks are a frequent sort of hash function attack in which an attacker attempts to identify two inputs that give the same hash value. Because the hard mathematical problem makes it more difficult for an attacker to identify two inputs that result in the same hash value, using the Collatz conjecture in a hashing function could potentially give higher resistance against collision assaults.

It is also another advantage of the present disclosure to be computationally efficient, making it suitable for use in hashing methods that require fast computation time.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. In addition, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE FIGURES

FIG. 1 shows an example of iterations that reduce 17 to 1 using Collatz Conjecture, according to an example embodiment of the present disclosure.

FIG. 2 is a graph showing the number of iterations required to reach 1 for first one million numbers, according to an example embodiment of the present disclosure.

FIG. 3 shows an encryption process using the proposed hash function, M=30, N=20, n=100, according to an example embodiment of the present disclosure.

FIG. 4 shows a decryption process using the proposed hash function, M=30, N=20, n=100, according to an example embodiment of the present disclosure.

FIGS. 5A-O are sample pictures (5A-E), the respective encrypted images (5F-J), and the respective decrypted images (5K-50), according to an example embodiment of the present disclosure.

FIGS. 6A-F are graphs showing: correlation distribution of two randomly picked neighboring pixels in Original Lena (6A); Encrypted Lena (6B); Original Peppers (6C) and Encrypted Peppers (6D); and the correlation of diagonal pixels in original Barbara and Encrypted Barbara, (6E and 6E, respectively), according to an example embodiment of the present disclosure.

FIGS. 7A-D show images and histograms at different phases of the proposed technique (7A Original Lena; 7B Histogram of plain Lena; 7C Encrypted Lena and 7D Histogram of Lena encrypted), according to an example embodiment of the present disclosure.

FIGS. 8A-D show images and histograms at different phases of the proposed technique (8A Original Barbara; 8B Histogram of plain Barbara; 8C Encrypted Barbara and 8D Histogram of Barbara encrypted), according to an example embodiment of the present disclosure.

### DETAILED DESCRIPTION

Methods, systems, and apparatus are disclosed herein for image encryption using Collatz Conjecture.

While the example methods, apparatus, and systems are disclosed herein for image encryption using Collatz Conjecture, it should be appreciated that the methods, apparatus, and systems may be operable for other applications.

The proposed technology combines Chaos theory and modified Collatz Conjecture to develop a hashing function that is used to encrypt digital images. It is impossible to overestimate the significance of image encryption utilizing hashing, especially in light of the growing need for secure data transmission and storage. The Collatz Conjecture, when combined with chaos theory, has the potential to produce high-quality encryption. The Collatz Conjecture is a tremendously complex mathematical problem, and its application in image encryption enhances the unpredictability and complexity of the process. The proposed technology is compared with various previously documented encryption techniques. The evaluation is conducted using a range of metrics, including histogram analysis, correlation coefficient, mean square error (MSE), number of pixels changes rate (NPCR), unified average change intensity (UACI), entropy, and time complexity.

This disclosure investigates using Collatz Conjecture as a cryptographic algorithm to address the increasing demand for secure information and data access. The proposed encryption method utilizes a hash function inspired by the Collatz Conjecture to achieve significant randomization while maintaining the input's integrity. The encryption scheme recursively adds the hash function's output to the neighboring pixel value, resulting in a highly secure encryption process. Several metrics were used to evaluate the proposed method's performance, and the findings show that it outperforms existing encryption algorithms in terms of data protection and computational speed. The proposed approach was evaluated using a range of established metrics, including but not limited to, encryption and decryption speed, memory usage, and resistance to attacks. The Collatz Conjecture provides a means to generate pseudo-random numbers that can serve as keys for encryption, offering a novel approach to encryption that can withstand new hacking techniques and technological advancements. In addition to addressing the need for secure data access, the proposed encryption method has applications in various fields, including medical and military imaging, where data privacy and security are crucial. The disclosed technology highlights the potential of the Collatz Conjecture as a new crypto-graphic algorithm and contribute to the development of encryption techniques that can ensure secure communication and protect sensitive data.

### Collatz Conjecture

The Collatz conjecture, commonly known as the 3n+1 mapping, is a mathematical conundrum that states that for any positive integer, there is a particular number of iterations that can reduce the number to one, by each n-th iteration T^{k}(n) is represented as a binary string and decoded to a distinct positive integer m.

$$T ( n ) = \{ \begin{matrix}\frac{n}{2} & if n is even \\ 3 n + 1 & if n is odd\end{matrix} . \qquad ( 1 )$$

$${σ}_{∞} ( n ) = inf \{ k : {T}^{k} ( n ) = 1 \} . \qquad ( 2 )$$

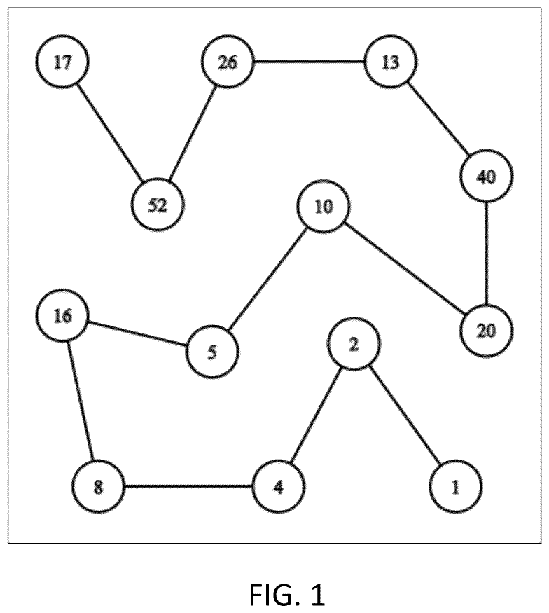

When dealing with numbers, the procedure used depends on their format, and T (n) is the next value (even or odd). Consider the case where the input number is 17. As this integer is odd, the initial operation is 3n+1. The final score is 52. Now, 52 is an even number, the value is now split by two. The final score is 26. The process is repeated iteratively using equation 1 until the result is 1. FIG. 1 shows an example of iterations that reduce 17 to 1 using Collatz Conjecture.

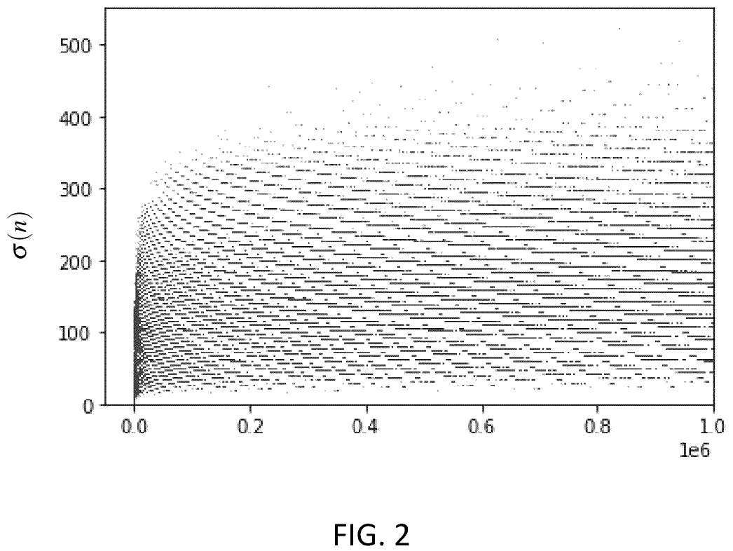

Obtaining the value 1 can take anything from 0 to an arbitrary number of iterations, making the Collatz hypothesis a rather peculiar proposition. Furthermore, with large or small numbers, the number of iterations can grow or decrease. As a result, the number n can reach 1 in m iterations, whereas the number n+1 can reach the number 1 in n iterations, given that n<m. This feature is useful for data encoding. FIG. 2 is a graph showing the number of iterations required to reach 1 for first one million numbers.

In the current digital era, preserving the confidentiality of sensitive information is crucial, and image encryption plays a crucial role in achieving this goal. As the quantity of electronic data transmitted and stored grows exponentially, the need for efficient and resilient image encryption methods is increasing. Hash functions have emerged as a promising substitute to conventional encryption techniques since they can encrypt images in a manner that makes the original image indecipherable. One-way functions, like hash functions, convert data into a string of characters of a predetermined length, making it difficult to reconstruct the original data from the string. This method protects the image's privacy and detects any attempts to tamper with the data.

### Hash Function Based on Chaos Theory, Sine Infinity, and Modified Collatz Conjecture

The proposed technology includes a hashing function based on the mathematical principles of the Collatz conjecture. The mathematical description of the function referred to as CollatzHash is given in function 3. The function takes the input in the standardized form between 0 and 1. The working of the hash function is captured in mathematical equations as below 3.

$${x}_{n + 1} = {10}^{M} \cdot \{ \begin{matrix}{R}_{K} ( f ( {x}_{n} ) sin ( g ( {x}_{n} ) ) + {x}_{n} ) , & if {x}_{n} ∈ ( ℝ - ℤ ) \\ ( \frac{{x}_{n}}{{2}^{j}} ) \times {P}_{{2}^{j}} + 1 , & if mod ( {x}_{n} , {2}^{j} ) = 0 , 3 \leq j \leq 5 \\ {R}_{K} ( f ( {x}_{n} ) sin ( g ( {x}_{n} ) ) + {x}_{n} ) & if mod ( {x}_{n} , {2}^{2} ) = 0 \\ ( \frac{{x}_{n}}{2} ) \times {P}_{2} + 1 , & if mod ( {x}_{n} , 2 ) = 0 \\ {x}_{n} \times {P}_{mo d ( {x}_{n} , {N}_{P} )} + 1 , & if mod ( {x}_{n} , 2 ) = 1\end{matrix} \qquad ( 3 )$$

In this equation, two variable parameters, K and M have been used where,

$${R}_{K} ( x ) = ⌊ \vert x \times {10}^{K} \vert ⌋ \qquad ( 4 )$$

The function f is a sinusoidal function with increasing period n∈[0,1].

$$f ( {x}_{n} ) = sin ( 2 π {e}^{{P}_{mod ( {n}_{1}^{n} \vert ( {N}_{P} ) \vert )} + 3} + α {X}_{n} ) + mod ( n , 5 ) - 2 \qquad ( 5 )$$

Where α=π, and the modulo function mod (x,y) being used in the CollatzHash function is the remainder of division of x by y, that is, mod (10,3)=1, mod (8,2)=0.

The function g is defined as follows:

$$g ( n ) = \vert ( {( \frac{mod ( n , 7 ) + 1}{{n}^{7} + {n}^{3} + n + 100} + \frac{mod ( n , 2 ) + 1}{{n}^{5} + 100} )}^{- 1} ) \vert \qquad ( 6 )$$

Where N_{P} is a list of primes used and P₁=3, P₂=3, P₃=5, . . . where the number Pi is i^{th} prime for i≥2. The function mod (x,y) gives the remainder when x is divided by y.

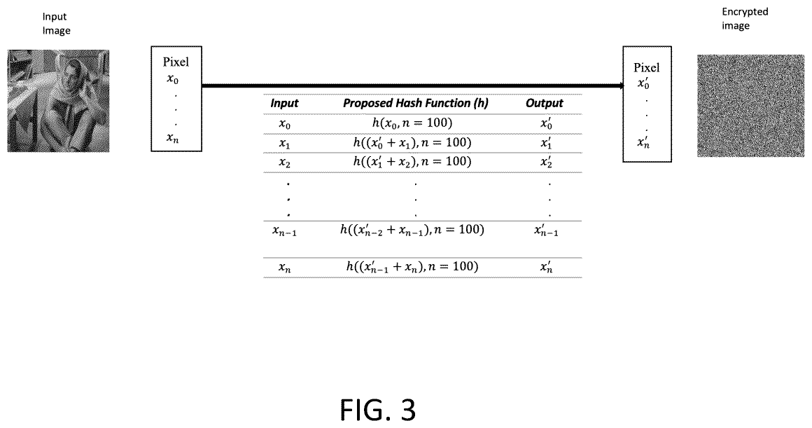

Encryption: FIG. 3 shows the encryption process using the proposed hash function, M=30, N=20, n=100. Pixel-to-pixel encryption using hash functions involves treating each pixel in the image as an independent data element. The proposed hash function is applied to each pixel, generating a unique hash value that is then utilized to encrypt the pixel. In this encryption process, the encrypted value of the previous pixel is added to the current pixel. The encryption process requires a secret key, which is generated beforehand and kept confidential. The key initializes the hash function, making the encryption process deterministic. The encrypted image is saved along with the secret key, which is necessary to decrypt the image. However, in the proposed hash function, the parameters (M,K,n) of hashing function serve as a key. Here is a step-by-step process as depicted in FIG. 3 for pixel-to-pixel image encryption using hash function:

1. Generate a key: Specify the parameters of the proposed hash function as a secret key for the encryption and decryption of the image. This key must remain confidential, with access granted solely to authorized parties.

2. Recursively add the results of a hash function with pixel values to scramble the original image.

3. Save the encrypted image: Store both the encrypted image and the secret key securely, as the key is essential for decrypting the image.

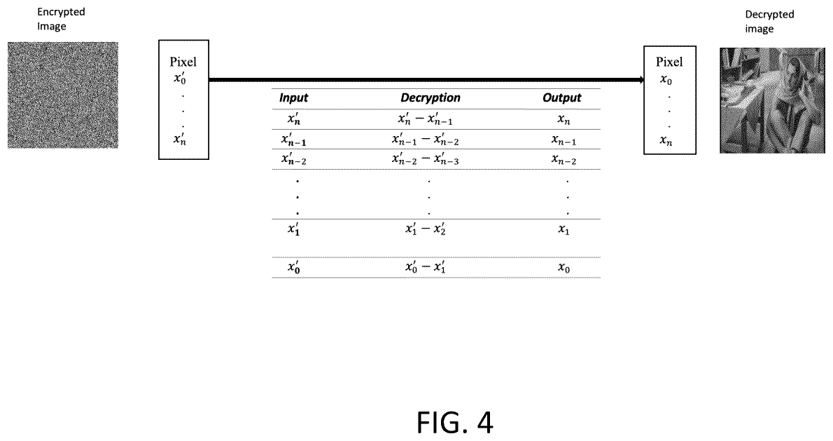

Decryption: FIG. 4 shows the decryption process using the proposed hash function, M=30, N=20, n=100. Decryption converts encrypted data to its original form using a secret key or password. In pixel-to-pixel image encryption using hash functions, decryption reverses the encryption process to produce the original, unencrypted image. To decrypt an image that has been encrypted using pixel-to-pixel image encryption with hash functions, you need the secret key that was used to encrypt the image. The secret key is used to initialize the hash function and to perform the XOR operation required to reverse the encryption process.

Here are the steps for decrypting an image depicted in FIG. 4 that has been encrypted using pixel-to-pixel image encryption with hash functions:

1. Obtain the secret key: To decrypt the image, the parameters are used as the secret key. These parameters must be the same as encryption.

2. Decrypt each pixel: For each pixel in the encrypted image, consult the hash table to map the pixel value with its corresponding hash value to obtain the original pixel value.

3. Reconstruct the image: Once all the pixels are decrypted, reconstruct the original image by putting the pixels back together in their original positions. It is important to note that decryption can only be performed with the correct secret key.

### Performance Analysis

The proposed encryption technique excels in efficiency and security, effectively withstanding a range of known attacks, including brute-force, differential, and statistical attacks. These results highlight the efficacy and robustness of the proposed approach and emphasize its potential as a viable encryption solution.

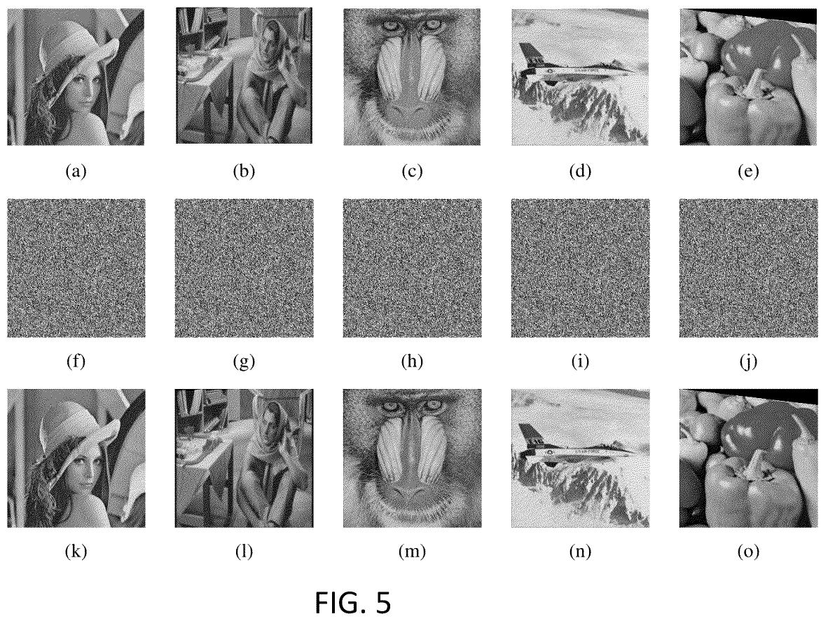

Encryption and Decryption Result: FIG. 5 and illustrates the proposed image encryption and decryption procedure with several examples chosen to showcase its versatility. In this proof-of-concept experiment, Lena, Baboon, Barbara, Peppers, and Airplane images of different sizes are used to demonstrate the algorithm's flexibility. FIGS. 5A-O are sample pictures (5A-E), the respective encrypted images (5F-J), and the respective decrypted images (5K-50).

Speed Performance: The speed at which a cryptosystem operates is also a key indicator of its effectiveness. Running time is determined for the Lena image in sizes 256×256, 512×512, and 1024×1024 and compared to the algorithms in and the DES method. Table 1 displays the numerical results, which demonstrate the proposed method's superior speed performance compared to the other algorithms considered. This rate is best suited for use in any online activity.

TABLE 1
Speed performance in ms for various image sizes with parameters of the proposed
hash function set to M = 30, N = 20, n = 100.

| | | Brindha, M., | Yun-peng, Z., Wei, L., | |
|---|---|---|---|---|
| | | Ammasai Gounden, | Shui-ping, C., Zheng- | |
| | | N.: A chaos based | jun, Z., Xuan, N., Wei- | Alawida, M., Teh, J. S., |
| | | image encryption and | di, D.: Digital image | Samsudin, A., Alshoura, |
| | | lossless com- | encryption algorithm | W. H.: An image |
| | | pression algorithm | based on chaos and | encryption scheme |
| | | using hash table and | improved DES. In: 2009 | based on hybridizing |
| | | Chinese Remainder | IEEE International | digital chaos and finite |
| Size of | Proposed | Theorem. Applied | Conference on Systems, Man | state machine. Signal |
| Input | Algorithm | Soft Computing 40, | and Cybernetics, pp. 474- | Processing 164, 249- |
| Image | (ms) | 379-390 (201 | 479. IEEE, (2009) | 266 (2019 |
| 256 × 256 | 14 | 18 | 47 | 127.2 |
| 512 × 252 | 38 | 50 | 70 | 515.6 |
| 1024 × 1024 | 189 | 278 | 655 | 2132.1 |

With the introduction of the fast iterative approach of chaos, the encryption algorithm has a low time complexity. The iterative chaotic scheme claims that the computation time complexity of the scrambling process reaches the logarithmic level, leading to a total time complexity of O(log(M+N)+M×N). Table 1 displays the encryption time and comparisons to other techniques. The proposed approach requires less time to encrypt images of varying sizes than two previous typical algorithms, which can be seen as an intuitive reflection of the advantages of the algorithm.

### Security Analysis

According to the cryptographic principles, a robust encryption scheme should be resistant to any possible form of attack, whether statistical, brute force, differential, etc. The resilience of a system against statistical attacks can be examined by its histogram and correlation analysis. A viable encryption technique should possess an extensive key space that renders brute-force attacks infeasible. The uniqueness of the encrypted image can be quantified with an entropy analysis. The robustness of an encryption scheme against differential attack is a function of the NPCR and UACI values.

Entropy Analysis—Image randomness can be measured with information entropy, which represents the distribution properties of pixel values. This measure is used to assess the unpredictability of image data, and it is written as 7, below.

$$H = - {\sum }_{c = 0}^{{2}^{B} - 1} p ( c ) \times {log}_{2} ( p ( c ) ) \qquad ( 7 )$$

where H denotes entropy of information source of image and c represents the possible value of a pixel, B is the number of bits used to represent a pixel c, and p(c) denotes the probability of pixel c appearing in image X.

In the context of information theory, the entropy of a source is a measure of the amount of uncertainty associated with its output symbols. If a source that produces 2L symbols in a uniformly distributed manner is assumed, the entropy value can be expressed as L. In the case of a grey-scale image, which typically contains 28 (i.e., 256) possible levels, the ideal entropy value would be eight. However, due to natural images' inherent structure and patterns, their entropy values tend to be lower than the ideal.

TABLE 2
Information Entropy for five different test images
of size 256 × 256 with parameters of the proposed
hash function set to M = 30, N = 20, n = 100.

| Image | Plain image | Encrypted Image |
|---|---|---|
| Lena | 7.16832629 | 7.999289178 |
| Baboon | 7.59686259 | 7.958073229 |
| Barbara | 6.55164573 | 7.962266587 |
| Peppers | 6.32697246 | 7.957549273 |
| Airplane | 6.71098089 | 7.957205416 |

Ensuring a sufficiently high entropy is critical in image encryption as lower entropy values can compromise the security of the cryptosystem. Specifically, an image encryption technique must generate symbols with an information entropy value of at least 8 to avoid potential vulnerabilities. To measure entropy in practice, five standard test photos are used, namely Lena, Baboon, Barbara, Peppers, and Airplane, as benchmarks. The calculated outcomes are dis-played in Table 2. In this scenario, 7.966876737 is derived by averaging the entropy values of the five test images. It is a remarkable approximation of the theoretical value 8. This implies that minimal data loss occurs throughout the encryption process. The entropy values of various algorithms are charted in table 3 for a fair comparison. The proposed chaos theory-based hash generation approach creates random values that are uniformly dispersed across the possible range of values, resulting in high entropy. When a chaotic map is iterated on an initial value, the ensuing series of values can have a high entropy because the values are highly unpredictable and appear random. Furthermore, the resulting sequence is often spread equally across the possible range of values, which is critical for ensuring that the sequence is not biased.

TABLE 3
Comparison of Information Entropy for five different test images
of three different sizes with parameters of the proposed hash
function set to M = 30, N = 20, n = 100 with state of art.

| | | Abdel-Aziz, M. M., Hosny, K. M., | Wang, Y., Chen, L., Yu, K., Lu, |
|---|---|---|---|
| | | Lashin, N. A.: Improved data | T.: Image encryption algorithm |
| | | hiding method for | based on lattice hash |
| | | securing color images. | function and privacy protection. |
| | Proposed | Multimedia Tools and | Multimedia Tools and |
| | algorithm | Applications 80(8), | Applications 81(13), 18251- |
| Image | entropy | 12641-12670 (2021) | 18277 (2022) |

256 × 256

| | | | |
|---|---|---|---|
| Lena | 7.9993 | 7.9968 | 7.9984 |
| Baboon | 7.9981 | 7.9973 | 7.9952 |
| Barbara | 7.9962 | 7.6994 | 7.9973 |
| Peppers | 7.9975 | 7.9961 | 7.9906 |
| Airplane | 7.9972 | 7.9968 | 7.9654 |

512 × 512

| | | | |
|---|---|---|---|
| Lena | 7.9993 | 7.9993 | 7.9942 |
| Baboon | 7.9981 | 7.9994 | 7.8943 |
| Barbara | 7.9992 | 7.9972 | 7.8945 |
| Peppers | 7.9997 | 7.9994 | 7.9923 |
| Airplane | 7.9997 | 7.9994 | 7.6745 |

1024 × 1024

| | | | |
|---|---|---|---|
| Lena | 7.9993 | 7.9993 | 7.9234 |
| Baboon | 7.9981 | 7.9994 | 7.6578 |
| Barbara | 7.9999 | 7.9972 | 7.9235 |
| Peppers | 7.9999 | 7.9994 | 7.6235 |
| Airplane | 7.9999 | 7.9994 | 7.8654 |

Statistical Attack—All cryptosystems are vulnerable to Shannon's outlined statistical attack methods. Therefore, a crypto system's ability to withstand a statistical attack is crucial in establishing its overall strength. This section discusses the two most prevalent types of tests and their outcomes.

Correlation of adjacent pixels—When an image has a high correlation between neighbouring pixels, it can impede the rapid diffusion of data and increase the likelihood of statistical attacks. To evaluate the propagation effect of the proposed technique, the correlation between neighboring pixels in both the plain and encrypted images is randomly compared. This evaluation aims to gauge the influence of the encryption process on the interdependence of neighboring pixels and examine the efficacy of the novel method in mitigating the potential threat of statistical attacks.

The following equation is a correlation of a pixel area centered around a pixel:

$$C ( n ) = {\sum }_{k} x ( k ) x ( n - k ) \qquad ( 8 )$$

$$C ( n , m ) = {\sum }_{{k}_{1}} {\sum }_{{k}_{2}} x ( {k}_{1} , {k}_{2} ) x ( n - {k}_{1} , m - {k}_{2} ) \qquad ( 9 )$$

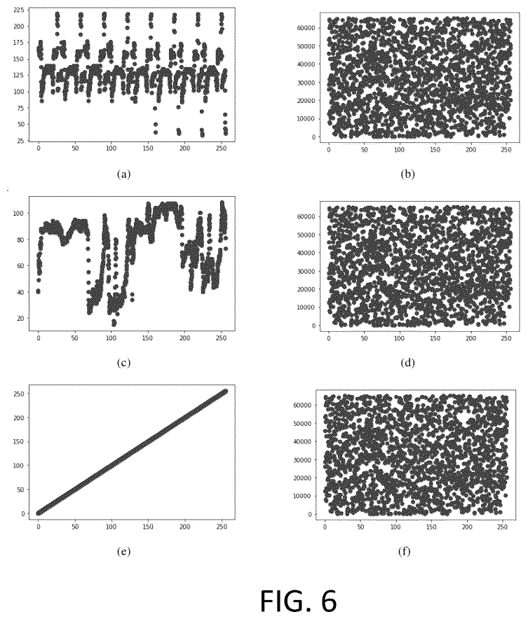

The original image and the encrypted image, depicted in FIG. 6A and FIG. 6B, respectively, were subjected to the random selection of 6000 pairs of adjacent pixels for the generation of distribution diagrams. The correlation diagram in FIG. 6 exhibits visible horizontally dispersed pixels, suggesting that the suggested encryption technique significantly minimizes the correlations between neighboring pixels in the original image.

The equation for determining the correlation coefficient Cor between two images P and C with pixel values P(i, j) and C(i, j) respectively is

$$Cor = \frac{E ( ( P ( i , j ) - E ( P ) ) ( C ( i , j ) - E ( C ) )}{\sqrt{σ ( P ) σ ( C )}} \qquad ( 10 )$$

$$E ( P ) = \frac{{\sum }_{i} {\sum }_{j} P ( i , j )}{W \times H} \qquad ( 11 )$$

$$E ( C ) = \frac{{\sum }_{i} {\sum }_{j} C ( i , j )}{W \times H} \qquad ( 12 )$$

$$σ ( P ) = \frac{\sqrt{{\sum }_{i} {\sum }_{j} {P ( ( i , j ) - E ( P ) )}^{2}}}{W \times H} \qquad ( 13 )$$

$$σ ( C ) = \frac{\sqrt{{\sum }_{i} {\sum }_{j} {C ( ( i , j ) - E ( C ) )}^{2}}}{W \times H} \qquad ( 14 )$$

where E(P) and E(Q) represent the mean of the pixel values in original image P and encrypted image C, respectively. σ(P) and σ(C) are the standard deviations of the pixel values in images P and C, respectively, and W and H are the dimensions of the images (i.e., number of rows and columns).

To calculate E(P) and σ(P) for each P value and each C value individually, 6000-pixel pairs are sampled and calculated separately. For plain images, the correlation is almost 1, as there is a strong relationship between neighboring pixels. Good cipher images have low (or zero) correlation in all three dimensions (horizontal, vertical, and diagonal). Table 4 compares the proposed scheme's correlation values to those of the existing schemes.

The data in table 4 suggests that the proposed algorithm can withstand statistical analysis. It proves that the attackers cannot derive anything valuable from statistical analysis.

Histogram—The distribution of an image's pixel values is visually depicted by a histogram, showcasing the frequency of occurrence for each pixel value. The regularity of the cipher image's histogram is critical to its security in image encryption. A uniform histogram suggests that the encrypted image's pixel values are distributed randomly and do not reveal any information about the original image.

TABLE 4
Comparison of correlation among various encryption schemes with parameters
of the proposed hash function set to M = 30, N = 20, n = 100

| Image | Encryption Scheme | Correlation |
|---|---|---|
| Lena | Zhu, H., Zhao, C., Zhang, X.: A novel image encryption-compression | 0.0198 |
| | scheme using hyper-chaos and Chinese remainder theorem. Signal | |
| | Processing: Image Communication 28(6), 670-680 (2013) | |
| | Wang, B., Zheng, X., Zhou, S., Zhou, C., Wei, X., Zhang, Q., Che, C.: | 0.0141 |
| | Encrypting the compressed image by chaotic map and arithmetic coding. | |
| | Optik 125(20), 6117-6122 (2014) | |
| | Wang, X., Zhang, X., Gao, M., Tian, Y., Wang, C., Iu, H. H.-C.: A Color | 0.0026 |
| | Image | |
| | Encryption Algorithm Based on Hash Table, Hilbert Curve and Hyper- | |
| | Chaotic Synchronization. Mathematics 11(3), 567 (2023) | |
| | Brindha, M., Ammasai Gounden, N.: A chaos based image encryption and | 0.002 |
| | lossless compression algorithm using hash table and Chinese Remainder | |
| | Theorem. Applied Soft Computing 40, 379-390 (2016) | |
| | Proposed scheme | −0.0006 |
| Baboon | Zhu, H., Zhao, C., Zhang, X.: A novel image encryption-compression | 0.0094 |
| | scheme using hyper-chaos and Chinese remainder theorem. Signal | |
| | Processing: Image Communication 28(6), 670-680 (2013) | |
| | Wang, B., Zheng, X., Zhou, S., Zhou, C., Wei, X., Zhang, Q., Che, C.: | 0.0141 |
| | Encrypting the compressed image by chaotic map and arithmetic coding. | |
| | Optik 125(20), 6117-6122 (2014) | |
| | Wang, X., Zhang, X., Gao, M., Tian, Y., Wang, C., Iu, H. H.-C.: A Color | 0.0024 |
| | Image | |
| | Encryption Algorithm Based on Hash Table, Hilbert Curve and Hyper- | |
| | Chaotic Synchronization. Mathematics 11(3), 567 (2023) | |
| | Brindha, M., Ammasai Gounden, N.: A chaos based image encryption and | 0.0033 |
| | lossless compression algorithm using hash table and Chinese Remainder | |
| | Theorem. Applied Soft Computing 40, 379-390 (2016) | |
| | Proposed scheme | 0.0002 |
| Barbara | Zhu, H., Zhao, C., Zhang, X.: A novel image encryption-compression | 0.0214 |
| | scheme using hyper-chaos and Chinese remainder theorem. Signal | |
| | Processing: Image Communication 28(6), 670-680 (2013) | |
| | Wang, B., Zheng, X., Zhou, S., Zhou, C., Wei, X., Zhang, Q., Che, C.: | 0.0126 |
| | Encrypting the compressed image by chaotic map and arithmetic coding. | |
| | Optik 125(20), 6117-6122 (2014) | |
| | Wang, X., Zhang, X., Gao, M., Tian, Y., Wang, C., Iu, H. H.-C.: A Color | 0.0023 |
| | Image | |
| | Encryption Algorithm Based on Hash Table, Hilbert Curve and Hyper- | |
| | Chaotic Synchronization. Mathematics 11(3), 567 (2023) | |
| | Brindha, M., Ammasai Gounden, N.: A chaos based image encryption and | 0.0015 |
| | lossless compression algorithm using hash table and Chinese Remainder | |
| | Theorem. Applied Soft Computing 40, 379-390 (2016) | |
| | Proposed scheme | 0.0004 |
| Peppers | Zhu, H., Zhao, C., Zhang, X.: A novel image encryption-compression | 0.0058 |
| | scheme using hyper-chaos and Chinese remainder theorem. Signal | |
| | Processing: Image Communication 28(6), 670-680 (2013) | |
| | Wang, B., Zheng, X., Zhou, S., Zhou, C., Wei, X., Zhang, Q., Che, C.: | 0.0198 |
| | Encrypting the compressed image by chaotic map and arithmetic coding. | |
| | Optik 125(20), 6117-6122 (2014) | |
| | Wang, X., Zhang, X., Gao, M., Tian, Y., Wang, C., Iu, H. H.-C.: A Color | 0.0035 |
| | Image | |
| | Encryption Algorithm Based on Hash Table, Hilbert Curve and Hyper- | |
| | Chaotic Synchronization. Mathematics 11(3), 567 (2023) | |
| | Brindha, M., Ammasai Gounden, N.: A chaos based image encryption and | 0.0026 |
| | lossless compression algorithm using hash table and Chinese Remainder | |
| | Theorem. Applied Soft Computing 40, 379-390 (2016) | |
| | Proposed scheme | 0 |
| Airplane | Zhu, H., Zhao, C., Zhang, X.: A novel image encryption-compression | 0.0028 |
| | scheme using hyper-chaos and Chinese remainder theorem. Signal | |
| | Processing: Image Communication 28(6), 670-680 (2013) | |
| | Wang, B., Zheng, X., Zhou, S., Zhou, C., Wei, X., Zhang, Q., Che, C.: | 0.0061 |
| | Encrypting the compressed image by chaotic map and arithmetic coding. | |
| | Optik 125(20), 6117-6122 (2014) | |
| | Wang, X., Zhang, X., Gao, M., Tian, Y., Wang, C., Iu, H. H.-C.: A Color | 0.0057 |
| | Image | |
| | Encryption Algorithm Based on Hash Table, Hilbert Curve and Hyper- | |
| | Chaotic Synchronization. Mathematics 11(3), 567 (2023) | |
| | Brindha, M., Ammasai Gounden, N.: A chaos based image encryption and | 0.0083 |
| | lossless compression algorithm using hash table and Chinese Remainder | |
| | Theorem. Applied Soft Computing 40, 379-390 (2016) | |
| | Proposed scheme | −0.0006 |

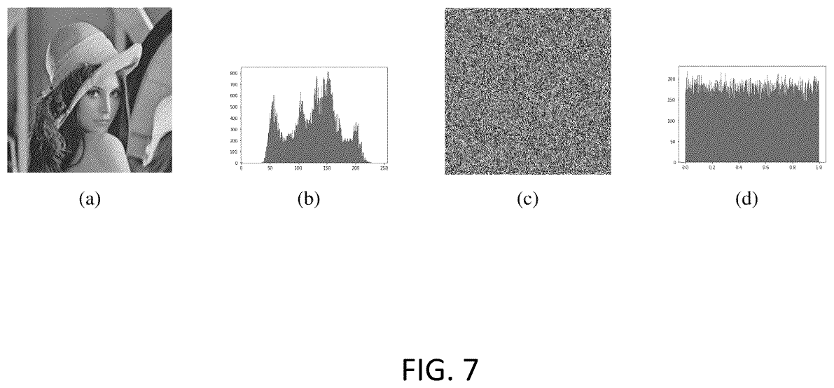

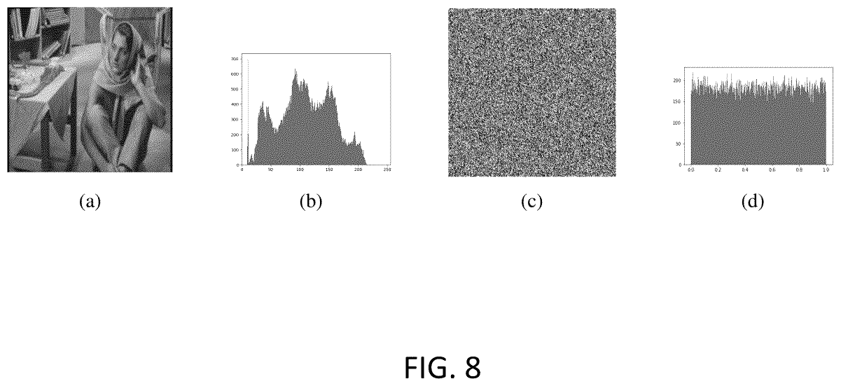

FIGS. 6A-F are graphs showing: correlation distribution of two randomly picked neighboring pixels in Original Lena (6A); Encrypted Lena (6B); Original Peppers (6C) and Encrypted Peppers (6D); and the correlation of diagonal pixels in original Barbara and Encrypted Barbara, (6E and 6E, respectively). FIGS. 7A-D show images and histograms at different phases of the proposed technique (7A Original Lena; 7B Histogram of plain Lena; 7C Encrypted Lena and 7D Histogram of Lena encrypted). FIGS. 8A-D show images and histograms at different phases of the proposed technique (8A Original Barbara; 8B Histogram of plain Barbara; 8C Encrypted Barbara and 8D Histogram of Barbara encrypted).

The histograms of two plaintext images (Lena, Barbara) and their matching cipher images are shown in FIGS. 7 and 8. The cipher images as depicted in 7C and 8C, have uniformly distributed histograms, suggesting the efficiency of the proposed encryption technique in concealing plaintext information and its resistance to statistical attacks such as histogram analysis. As depicted in FIGS. 7B and 8B, the histogram of plaintext images showcases the frequency distribution of pixel values. However, after applying the Collatz-based hash function for encryption, the histogram of the encrypted image displayed in FIGS. 7D and 8D illustrates the loss of the typical pixel value distribution found in the original image. This loss precludes any possibility of determining the original image's pixel values. Furthermore, extensive parallel experiments reveal that the histograms of ciphertexts for various source images resemble those depicted in FIG. 7D. Therefore, adversaries are unable to gain any valuable insights from analyzing the histograms of encrypted images.

Differential Attack—To compare the plain and cipher images, it is possible to modify the plain image and observe the resulting changes in the cipher image. This approach enables precise and uncomplicated comparison between the two images, with minor modifications, such as a single pixel value or bit, indicating significant changes. For an image encryption algorithm to be successful, it must be immune to differential attacks, which can compromise the security of the cipher image. Standard quantitative measures such as the Uniform Average Changing Intensity (UACI) and the Number of Pixels Changing Rate (NPCR) are commonly employed to evaluate the resilience of an encryption algorithm to differential attacks.

Unified Average Changing Intensity (UACI)—Using the maximum pixel value (2H−1=255) in grayscale images, UACI determines the average variation in pixel brightness at matching points in both cipher images. Table 5 dis-plays the results of applying equation 15 to the standard test pictures to determine the UACI value for the proposed system and the comparison with other state of art methods is presented in table 6.

$$UACI = \frac{{\sum }_{i - 1}^{W} {\sum }_{j - 1}^{H} \vert {C}_{1} ( i , j ) - {C}_{2} ( i , j ) \vert}{255 \times W \times H} \times 100 \% \qquad ( 15 )$$

where C1 and C2 represent the first and second cipher images produced after random pixel modification to a plain image. W and H are the width and height of the images

Further, assuming the data distribution in the histogram of original image is perfectly uniform and normally distributed, the UACI value will be 33%. Here is presented the mathematical proof of the minimum UACI value for a uniformly distributed histogram of an image in equation 16. Let a and X be two random variables representing the relative histogram, the support is normalized between 0 and 1 of the input image and the encrypted image, respectively.

Assuming that a is uniformly distributed over the interval [0,1], the expected value of the difference between the original and encrypted image, E|X−α|, is needed to be calculated to evaluate different techniques of encryption.

Using conditional expectation, the present disclosure has the following

$$\begin{matrix}E ( \vert X - α \vert ) = E ( E ( ( \vert X - α \vert ) \vert α ) ) \\ = \text{?} ( α - x ) f ( x \vert α ) dx + \text{?} ( x - α ) f ( x \vert α ) dx\end{matrix} \qquad ( 16 )$$

$$f ( X \vert α ) \sim U [ 0 , 1 ]$$

$$Since α \sim U ( 0 , 1 ) , therefore ,$$

$$\begin{matrix}E ( \vert X - α \vert ) = E ( {\int }_{0}^{1} ( \vert x - α \vert ) dx ) \\ = E ( \text{?} ( x - α ) dx + \text{?} ( x - α ) dx ) \\ = E ( {[ α x - \frac{{x}^{2}}{2} ]}_{0}^{α} + {[ \frac{{x}^{2}}{2} + α x ]}_{α}^{1} ) \\ = E ( {α}^{2} - \frac{{α}^{2}}{2} + ( \frac{1}{2} - α ) - ( \frac{{α}^{2}}{2} - {α}^{2} ) )\end{matrix}$$

$$Simplifying the question , we obtain$$

$$\begin{matrix}E ( \vert X - α \vert ) = E ( {α}^{2} + \frac{1}{2} - α ) \\ = \text{?} {α}^{2} dx + \frac{1}{2} - \text{?} α dx \\ = {[ \frac{{α}^{3}}{3} ]}_{0}^{1} + \frac{1}{2} - {[ \frac{α}{2} ]}_{0}^{1} \\ = \frac{1}{3} + \frac{1}{2} - \frac{1}{2} \\ = \frac{1}{3}\end{matrix}$$

$$Therefore , we can confidently conclude that$$

$$for a uniformly distributed data ,$$

$$E ( ( α - X ) ) = 33 \%$$

$$\text{?} \text{indicates text missing or illegible when filed}$$

However, in practical context of image encryption, the UACI value can be obtained using equation 17

$$E ( \vert X - α \vert ) \approx \frac{{\sum }_{i} {\sum }_{j} \vert X ( i , j ) - {X}^{′} ( i , j )}{{2}^{B}} \qquad ( 17 )$$

where B is the number of bits used to represent a pixel of an image.

Comparing Tables 5 and 6 reveals that the proposed technique is more secure against differential attacks. A high UACI value indicates that the encryption algorithm has produced an image significantly different from the original, which is desirable for security purposes, in which case the attacker would have difficulty reconstructing the original from the encrypted image. In summary, UACI is a critical metric for evaluating the effectiveness of image encryption algorithms, as it provides a quantitative measure of the degree of randomness or unpredictability in the encrypted image.

TABLE 5
UACI values of cipher images in different sizes.

| Image | 256 × 256 | 512 × 512 | 1024 × 1024 |
|---|---|---|---|
| Lena | 49.93 | 42.16 | 42.60 |
| baboon | 50.01 | 50.07 | 49.98 |
| Barbara | 49.99 | 50.00 | 50.05 |
| Peppers | 49.94 | 50.06 | 50.02 |
| Airplane | 49.85 | 49.97 | 49.97 |

TABLE 6
Comparison of UACI values for different sizes of Lena image with different algorithms
and proposed hash function with parameters M = 30, N = 20, n = 100.

| | | | Wang, X., Zhang, X., | |
|---|---|---|---|---|
| | | Wang, Y., Chen, L., | Gao, M., Tian, Y., Wang, | Abedzadeh, M., |
| | | Yu, K., Lu, T.: Image | C., Iu, H. H.-C.: A Color | Rostami, M. J., |
| | | encryption algorithm | Image | Shariatzadeh, M.: Image |
| | | based on lattice hash | Encryption Algorithm | encryption using a stan- |
| | | function and privacy | Based on Hash Table, | dard map and a |
| | | protection. Multimedia | Hilbert Curve and Hyper- | teaching-learning based |
| | | Tools and | Chaotic Synchro- | optimization algorithm. |
| Image | Proposed | Applications 81(13), | nization. Mathematics | Multimedia Tools and |
| size | Algorithm | 18251-18277 (2022 | 11(3), 567 (2023) | Applications (2023) |
| 256 × 256 | 49.93 | 33.47 | 33.25 | 33.15 |
| 512 × 512 | 42.16 | 33.64 | 33.79 | 33.33 |
| 1024 × 1024 | 42.6 | 33.74 | 33.58 | 33.45 |

Number of Pixels Changing Rate (NPCR)—By utilizing two images—the original and a modified version with a single pixel value altered randomly-NPCR computes the number of pixels that have different values in the cipher image at corresponding positions. By applying equations 18 and 19, the NPCR of the suggested approach is evaluated on five benchmark test images.

$$NPCR = \frac{{\sum }_{i - 1}^{W} {\sum }_{j - 1}^{H} D ( i , j )}{W \times H} \times 100 \% \qquad ( 18 )$$

$$where$$

$$D ( i , j ) = \{ \begin{matrix}1 , if {C}_{1} \neq {C}_{2} \\ 0 , if {C}_{1} = {C}_{2}\end{matrix} \qquad ( 19 )$$

where (i, j) represents the coordinates of the pixel values, W×H is the image dimensions, C1 and C2 are two encrypted images of a plain image produced before and after a random pixel modification. The NPCR values obtained for benchmark images are presented in Table 7. The results reveal that the suggested method has a higher NPCR, indicating that it is resistant to differential attacks.

TABLE 7
NPCR values of cipher images in different sizes.

| Image | 256 × 256 | 512 × 512 | 1024 × 1024 |
|---|---|---|---|
| Lena | 95.58 | 84.02 | 84.79 |
| baboon | 99.59 | 99.57 | 99.59 |
| Barbara | 99.55 | 99.58 | 99.59 |
| Peppers | 99.6 | 99.55 | 99.59 |
| Airplane | 99.61 | 99.58 | 99.57 |

Mean Square Error—The Mean Square Error (MSE) is a quantitative metric that assesses the similarity between two images. It is computed by averaging the squared differences between corresponding pix-els in the original and decrypted images. A lower MSE value indicates a higher level of similarity, indicating that the decryption process has successfully preserved the image quality. This study obtained an MSE value of 0.0 for all original and decrypted images, indicating a high similarity level. Conversely, a higher MSE value suggests greater dissimilarity between the original and encrypted images. Let the original image P, and the resulting decrypted image is D, then MSE is calculated as

$$MSE ( P , D ) = \frac{{\sum }_{i - 1}^{W} {\sum }_{j - 1}^{H} {\vert P ( i , j ) - D ( i , j ) \vert}^{2}}{W \times H} \qquad ( 20 )$$

where (i, j) represents the coordinates of the pixel values, W×H is the image dimensions, P(i, j) and D(i, j) indicate the original and decrypted images, respectively.

The perfect value for this metric for a plain image histogram can be obtained using the mathematical formula 21. Let α and X be two random variables representing the relative histogram, the support is normalized between 0 and 1, of the input image and the encrypted image, respectively. Assuming the original image α is uniformly distributed over the interval [0,1], the expected value of the differences between the original and encrypted image is needed to be calculated to evaluate different techniques of encryption. Using conditional expectation, the present disclosure has the following

$$\begin{matrix}E ( {\vert α - X \vert}^{2} ) = E ( E ( {( α - X )}^{2} \vert α ) ) \\ = E ( E ( {α}^{2} - 2 α X \vert α + ( {X}^{2} \vert α ) ) \\ = E ( {α}^{2} - 2 E ( α X \vert α ) + {E ( X \vert α )}^{2} )\end{matrix} \qquad ( 21 )$$

It is important to note that at this step, perfect encryption is achieved when α and X are independent random variables.

$$\begin{matrix}E ( {\vert α - X \vert}^{2} ) = E ( {α}^{2} ) - 2 E ( x ) E ( α ) + E ( {X}^{2} ) \\ = E ( {α}^{2} ) - E ( α ) + {\int }_{0}^{1} {x}^{2} dx \\ = E ( {α}^{2} ) - E ( α ) + \frac{1}{3}\end{matrix}$$

Assuming the original image, a is uniformly distributed between 0 and 1,0

$$\begin{matrix}E ( {\vert α - X \vert}^{2} ) = {\int }_{0}^{1} {α}^{2} dx - {\int }_{0}^{1} α dx + \frac{1}{3} \\ = \frac{2}{3} - \frac{1}{2} \\ = \frac{1}{6}\end{matrix}$$

However, in practical context of image encryption, the mean square value (MSE) can be obtained using equation 22.

$${E ( \vert X - α \vert )}^{2} \approx \frac{{\sum }_{i} {\sum }_{j} {\vert X ( i , j ) - {X}^{′} ( i , j ) \vert}^{2}}{{2}^{2 B}} \qquad ( 22 )$$

While MSE can assist in evaluating image encryption schemes, it has significant limitations. One shortcoming is that it just evaluates the average difference between pixel values and fails to explain how these discrepancies are distributed. This means that two encrypted images with the same MSE value, but differing levels of security are possible.

Also, MSE does not consider the human perception of image quality. An encrypted image with a low MSE value may still appear visually different from the original image, affecting its usability in specific applications. However, as seen in table 8, the proposed algorithm produces a higher MSE for all images and their encrypted counterparts. In summary, MSE is a valuable metric for evaluating the effectiveness of image encryption algorithms. Still, it should be used with other metrics, such as UACI, to obtain a more comprehensive assessment of an algorithm's security and usability.

TABLE 8
Comparison of Mean Square Error for Plain and Encrypted
Images Using Proposed Hash Function with Parameters M = 30,
N = 20, and n = 100 across different image sizes.

| | | | | Arif, J., Khan, M. A., |
|---|---|---|---|---|
| | | | | Ghaleb, B., Ahmad, J., |
| | | | Alghamdi, Y., | Munir, A., Rashid, U., Al- |
| | | | Munir, A., Ahmad, | Dubai, A. Y.: A |
| | | | J.: A Lightweight | Novel Chaotic |
| | | | Image Encryption | Permutation-Substitution |
| | | | Algorithm Based | Image Encryption Scheme |
| | | | on Chaotic Map and | Based on Logistic |
| | | | Random | Map and Random |
| | | Proposed | Substitution. Entropy | Substitution. IEEE Access |
| Image | Image Size | Algorithm | 24(10), 1344 (2022) | 10, 12966-12982 (2022) |
| Lena | 256 × 256 | 50.6 | 39.6 | 39.4 |
| | 512 × 512 | 51.6 | 49.8 | — |
| | 1024 × 1024 | 51.4 | 40.3 | — |
| Baboon | 256 × 256 | 53.5 | 42.6 | 39.7 |
| | 512 × 512 | 53.7 | 46 | — |
| | 1024 × 1024 | 1024 | 53.8 | 51.6 |
| Barbara | 256 × 256 | 40.2 | 26.5 | 35.9 |
| | 512 × 512 | 45.7 | 39.7 | — |
| | 1024 × 1024 | 1024 | 45.7 | 33.4 |
| Peppers | 256 × 256 | 47.5 | 23.6 | 39 |
| | 512 × 512 | 49.8 | 42.4 | — |
| | 1024 × 1024 | 49.9 | 41.8 | — |
| Airplane | 256 × 256 | 74.4 | 34.7 | 39.8 |
| | 512 × 512 | 74.7 | 53.7 | — |
| | 1024 × 1024 | 74.8 | 57.5 | — |

This work explores the potential use of the Collatz Conjecture as a new cryptographic algorithm in response to the growing demand for information and data security. With the rise of more advanced techniques for breaking existing algorithms, which heavily rely on prime numbers, it has become increasingly important to explore alternative approaches. The proposed algorithm integrates multiple chaos theory and Collatz Conjecture to achieve high image security while maintaining low computational complexity. It is a perfect fit for high-security real-time video communication applications. The hash function generates unique hash values for each pixel, which have yielded satisfactory results for evaluation metrics like Entropy, NPCR (Number of Pixel Change Rate), UACI changing (Unified Average Changing Intensity), and mean square error. Additionally, image encryption using hashing has demonstrated superior speed and efficiency compared to other encryption techniques, making it ideal for various applications where both security and speed are crucial, such as real-time video streaming and multimedia transmission.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A system for image encryption based on the Collatz Conjecture comprising:
a server;
a processor; and
a memory storing instructions, which when executed by the processor, cause the processor to
apply a cryptographic algorithm based on the Collatz Conjecture.

2. The system of claim 1, wherein the cryptographic algorithm includes a pixel-to-pixel encryption and a pixel-to-pixel decryption phase.

3. The system of claim 2, wherein the pixel-to-pixel encryption phase uses a first hash function:
${x}_{n + 1} = {10}^{M} \cdot \{ \begin{matrix}{R}_{K} ( f ( {x}_{n} ) sin ( {gx}_{n} ) ) + {x}_{n} ) , & if {x}_{n} ϵ ( - ) \\ ( \frac{{x}_{n}}{{2}^{j}} ) \times {P}_{{2}^{j}} + 1 , & if mod ( {x}_{n} , {2}^{j} ) = 0 , 3 \leq j \leq 5 \\ ( R ( f ( {x}_{n} ) sin ( {gx}_{n} ) ) + {x}_{n} , & if mod ( {x}_{n} , {2}^{2} ) = 0 \\ ( \frac{{x}_{n}}{2} ) \times {P}_{2} + 1 , & if mod ( {x}_{n} , 2 ) = 0 \\ {x}_{n} \times {P}_{m o d ( {x}_{n} , {N}_{P} )} + 1 , & if mod ( {x}_{n} , 2 ) = 1\end{matrix}$
In this equation, two variable parameters, K and M, have been used, where,
${R}_{K} ( x ) = ⌊ \vert x \times 1 {0}^{K} \vert ⌋$
The function f is a sinusoidal function with increasing period n ∈ [0, 1].
$f ( {x}_{n} ) = sin ( 2 π {e}^{{P}_{m o d ( {n}^{N} , \vert {N}_{P} \vert )}} + 3 ) + α {X}_{n} + mod ( n , 5 ) - 2$
where α = 1 or α = 2.
The modulus function mod (x, y) being used in the CollatzHash function is
the remainder of division of x by y, that is, mod (10, 3) = 1, mod (8, 2) = 0.
The function g is defined as follows:
$g ( n ) = \vert ( {( \frac{mod ( n , 7 ) + 1}{{n}^{7} + {n}^{3} + n + 100} + \frac{mod ( n , 1 ) + 1}{{n}^{5} + 100} )}^{- 1} ) \vert$
where N_{P} is a list of primes used and P₁ = 3, P₂ = 3, P₃ = 5, . . . where the
number Pi = ith prime for i ≥ 2.

4. The system of claim 2, wherein the pixel-to-pixel decryption phase uses a second hash function:

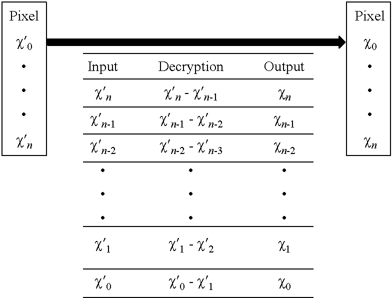

5. A method for image encryption based on the Collatz Conjecture comprising:
receiving an image;
applying a pixel-to-pixel encryption hash function;
applying a pixel-to-pixel decryption hash function; and
reconstructing the image.

6. The method of claim 5, wherein the pixel-to-pixel encryption hash function is:
$${x}_{n + 1} = 1 {0}^{M} . \{ \begin{matrix}{R}_{K} ( f ( {x}_{n} ) sin ( {gx}_{n} ) ) + {x}_{n} ) , if {x}_{n} ϵ ( - ) \\ ( \frac{{x}_{n}}{{2}^{j}} ) \times {P}_{{2}^{j}} + 1 , if mod ( {x}_{n} , {2}^{j} ) = 0 , 3 \leq j \leq 5 \\ ( R ( f ( {x}_{n} ) sin ( {gx}_{n} ) ) + {x}_{n} , if mod ( {x}_{n} , {2}^{2} ) = 0 \\ ( \frac{{x}_{n}}{2} ) \times {P}_{2} + 1 , if mod ( {x}_{n} , 2 ) = 0 \\ {x}_{n} \times {P}_{mod ( {x}_{n} , {N}_{P} )} + 1 , if mod ( {x}_{n} , 2 ) = 1\end{matrix}$$
In this equation, two variable parameters, K and M, have been used, where,
$${R}_{K} ( x ) = ⌊ \vert x \times {10}^{K} \vert ⌋$$
The function ƒ is a sinusoidal function with increasing period n∈[0, 1].
$$f ( {x}_{n} ) = sin ( 2 π {e}^{{P}_{m o d ( {n}^{N} , \vert {N}_{P} \vert )}} + 3 ) + α {X}_{n} + mod ( n , 5 ) - 2$$
where α=1 or α=2.
The modulus function mod (x, y) being used in the CollatzHash function is the remainder of division of x by y, that is, mod (10, 3)=1, mod (8, 2)=0.
The function g is defined as follows:
$$g ( n ) = \vert ( {( \frac{mod ( n , 7 ) + 1}{{n}^{7} + {n}^{3} + n + 100} + \frac{mod ( n , 1 ) + 1}{{n}^{5} + 100} )}^{- 1} ) \vert$$
where N_{P} is a list of primes used and P₁=3, P₂=3, P₃=5, . . . where the number
$$Pi = ith prime for i \geq 2 .$$

7. The method of claim 5, wherein the pixel-to-pixel decryption hash function is: [chemical structure]
